(19) United States
(12) Patent Application Publication
(10) Pub. No.: US 2013/0033732 A1
(43) Pub. Date: Feb. 7, 2013

(54) Rotating MEMS Scanner

(71) Applicants: Wyatt O. Davis, Bothell, WA (US); Hakan Urey, Istanbul (TR); Dean R. Brown, Lynnwood, WA (US); Utku Baran, Istanbul (TR); Jason B. Tauscher, Sammamish, WA (US); Sven Thage Sigvard Holmstrom, Istanbul (TR)

(72) Inventors: Wyatt O. Davis, Bothell, WA (US); Hakan Urey, Istanbul (TR); Dean R. Brown, Lynnwood, WA (US); Utku Baran, Istanbul (TR); Jason B. Tauscher, Sammamish, WA (US); Sven Thage Sigvard Holmstrom, Istanbul (TR)

(73) Assignee: Microvision, Inc., Redmond, WA (US)

(21) Appl. No.: 13/198,585

(22) Filed: Aug. 4, 2011

(51) Int. Cl. G02B 26/10

(52) U.S. Cl. 359/198.1

(57) ABSTRACT

Briefly, in accordance with one or more embodiments, a rotating scanning platform comprises a rotating body and two or more suspension flexures to support the rotating body at a first end of respective suspension flexures, wherein the suspension flexures have a length that is greater than a radius of the rotating body, and the suspension flexures are disposed at an offset from a center of rotation of the rotating body. The suspension flexures are fixed, respectively, to a substrate at a second end at a location that is closer to the center of rotation than to the first end of a respective suspension flexure to allow the rotating body to rotate about the center of rotation with generally linear rotation in response to a drive signal.

### BACKGROUND

Laser beam scanning is used for a wide variety of applications such as portable projectors, head-worn displays, and telecommunication systems. In such beam scanning systems, a rotating mirror is used to deflect a modulated light beam on an image plane to create a display. In order to construct a two-dimensional image, the mirror is rotated about two orthogonal axes with resonant or non-resonant motions. Biaxial motion is typically generated by a two-dimensional scanner. However, biaxial motion may also be generated by using two one-dimensional scanners, one scanner for each axis.

Higher performing scanners are either electromagnetically or electrostatically actuated. Electromagnetically actuated scanners involve the placement of large permanent magnets close to the scanning device, which can take up space. On the other hand, electrostatically actuated scanners typically may be fabricated to have a smaller, compact size, with the tradeoff being that higher voltages are involved to drive the scanner. However, typical out-of-plane comb scanners are generally suitable only for resonant actuation and do not respond to direct current (DC). Usually, such limitations are addressed by utilizing offset comb fingers or by using electrodes disposed on separate wafers. As a result, scan angles may be limited and linear motion may be difficult to achieve. As an alternative, in-plane rotation using curved comb fingers may be utilized to drive a scanning platform for laser scanning applications, however, in-plane scanners will typically feature suspension beams used in bending rather than in torsion, which tends to make their stiffness increase nonlinearly with the amplitude of the displacement. Such increasing stiffness limits the amplitude of quasistatic displacement that is achievable, and so the operation is again limited to resonance. Therefore, it has been challenging to fabricate an in-plane scanning platform with linear dynamics using such bending suspension beams.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1A is an isometric view of an optical device comprising a mirror disposed on a rotating microelectromechanical system MEMS scanner in accordance with one or more embodiments;

FIG. 1B is a diagram of an example beam scanning system having a rotating MEMS scanner with an optical device disposed thereon in accordance with one or more embodiments;

FIGS. 2A-2C are diagrams of various rotating scanning platforms in accordance with one or more embodiments;

FIGS. 3A-3B are diagrams of various rotating scanning platforms having non-linear support arms in accordance with one or more embodiments;

FIGS. 4A-4C is are diagrams of a rotating scanning platform showing various mechanisms for driving the scanner in accordance with one or more embodiments;

FIGS. 4D-4E are diagrams of a rotating scanning platform showing an example implementation in accordance with one or more embodiments;

FIG. 5 is a diagram of a rotating scanning platform having a mirror disposed thereon illustrating a scan cone in accordance with one or more embodiments;

FIG. 6 is a diagram of an array of rotating scanning platforms in a general hexagonal arrangement in accordance with one or more embodiments;

FIG. 7 is a diagram of an array of rotating scanning platforms in a general rectilinear arrangement in accordance with one or more embodiments;

FIGS. 8A and 8B are diagram of an array of rotating scanning platforms used as a dynamic aperture or to reduce speckle in accordance with one or more embodiments;

FIG. 9 is a diagram of a phased array of rotating scanning platforms used for beam steering in accordance with one or more embodiments;

FIG. 10 is a diagram of a biaxial scanner including a rotating scanning platform in accordance with one or more embodiments;

FIG. 11 is an isometric view of a projector having the scanning system with a rotating scanning platform of FIG. 1B in accordance with one or more embodiments;

FIG. 12 is an isometric view of an information handling system having a scanning system that includes a rotating scanning platform in accordance with one or more embodiments; and

FIG. 13 is a block diagram of an example architecture of the information handling system of FIG. 12 in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

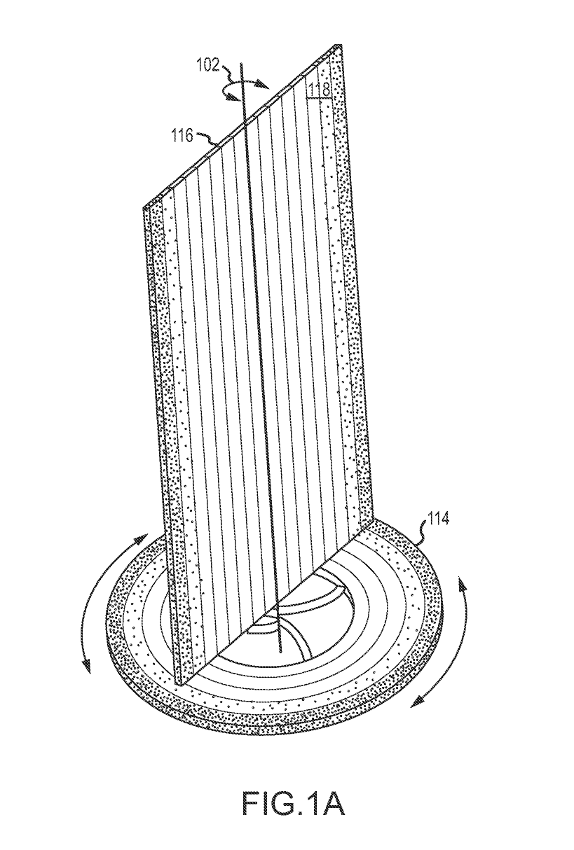

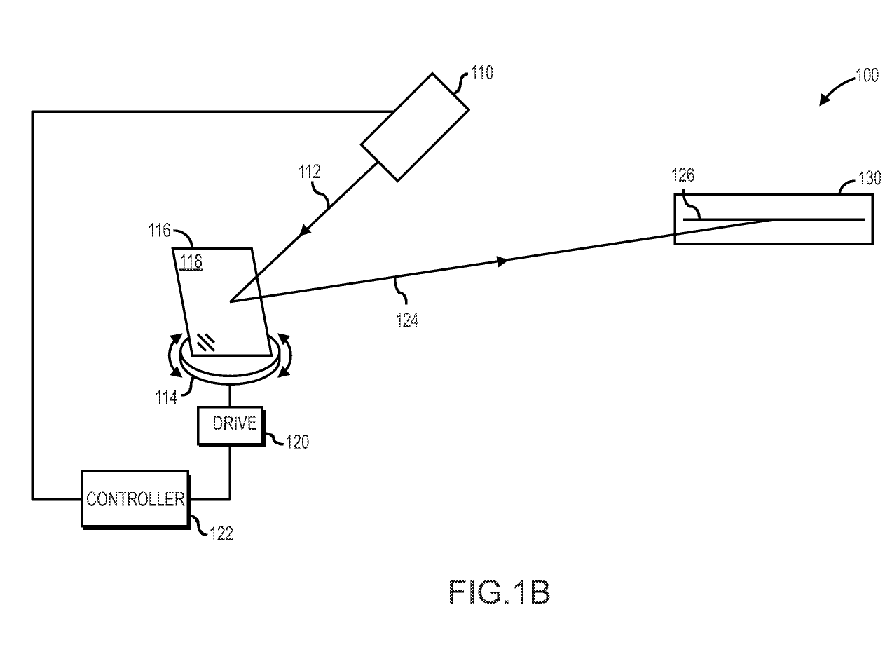

Referring now to FIG. 1A, an isometric view of an optical device comprising a mirror disposed on a rotating microelectromechanical system (MEMS) scanner in accordance with one or more embodiments. As shown in FIG. 1A, a rotating MEMS scanner 114 may be driven to rotate back and forth about a rotational axis 102 such that an optical device 116 is caused to rotate about axis 102. In one or more embodiments, the optical device 116 may comprise a mirror and/or which may have a mirrored surface 118 that is capable of reflecting a light beam and redirecting the light beam according to the rotational movement of the mirror. In such embodiments, optical device 116 may be referred to as a stand-up mirror in which the mirror is mounted vertically with respect to the plane in which the MEMS scanner 114 is rotating. In general, such a stand-up mirror may be mounted on MEMS scanner 114 such that a surface of the mirror is disposed to be non-planar with respect to the plan of rotation of the MEMS scanner. However, it should be noted that a mirror is merely one example of the type of device that optical device 116 may comprise, wherein optical device 116 may comprise various types of devices such as any type of mirror, a lens, a curved mirror, a prism, a diffraction grating, an aperture, an optical diffuser, or a microlens array, or combinations thereof, and the scope of the claimed subject matter is not limited in this respect. One example application of an optical device 116 comprising a stand-up mirror disposed on a rotating MEMS scanner 114 utilized in a beam scanning system is shown in and described with respect to FIG. 1B, below.

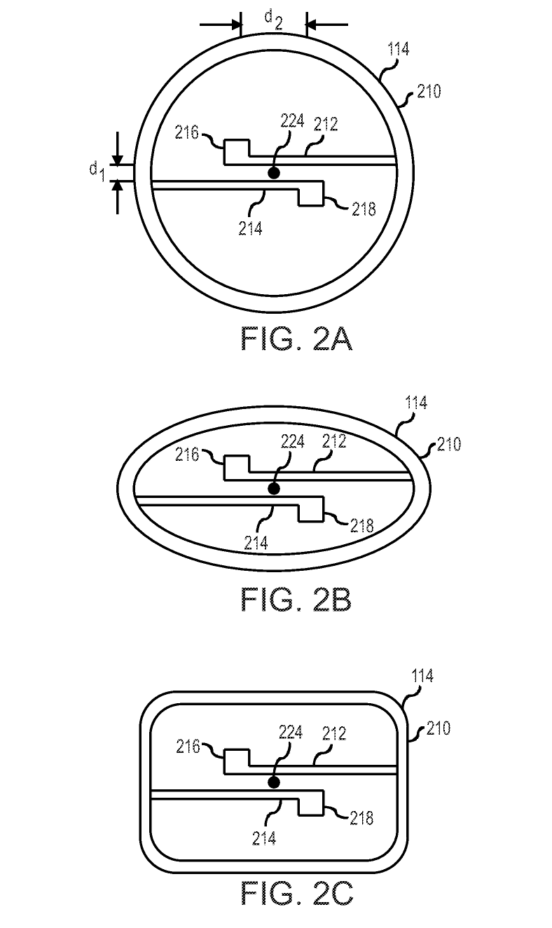

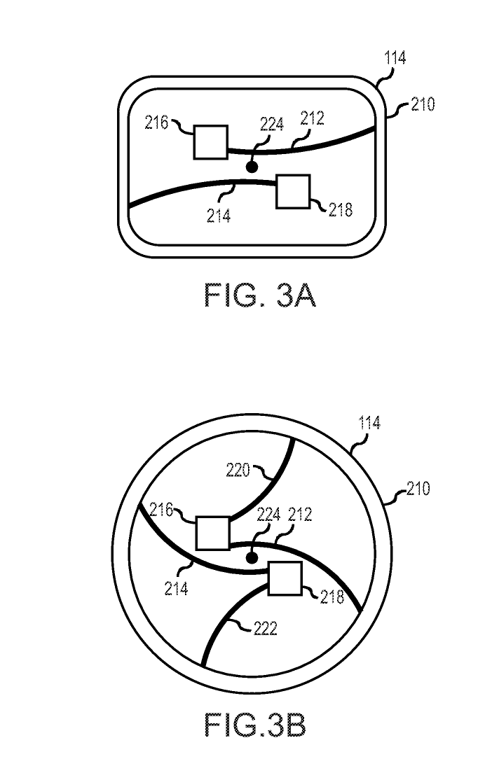

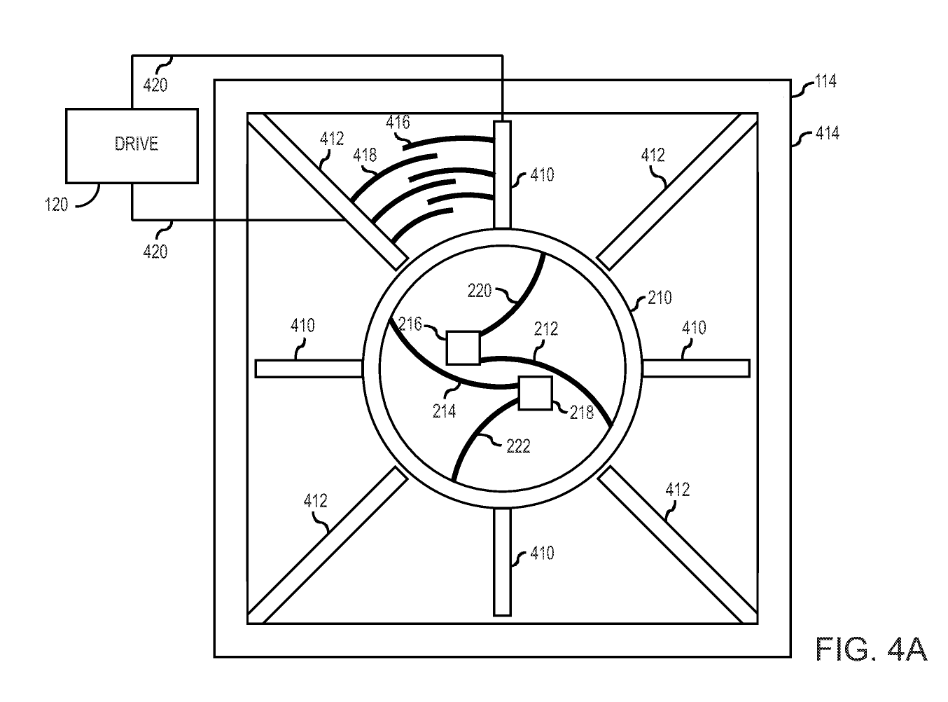

Referring now to FIG. 1B, a diagram of a beam scanning system having a rotating MEMS scanner in accordance with one or more embodiments will be discussed. As shown in FIG. 1B, scanning system 100 comprises a light source 110 capable of emitting a beam 112 such as a laser beam or other collimated or non-collimated beam. Beam 112 impinges on an optical device 116 disposed on a rotating scanning platform 114. In one or more embodiments, rotating scanning platform 114 may comprise a microelectromechanical machine system (MEMS) type device although the scope of the claimed subject matter is not limited in this respect. In one embodiment, optical device 116 may have a mirrored surface 118 to reflect beam 112 as scanned beam 124. In one or more particular embodiments, optical device 116 comprise a mirror that is oriented to be non-planar with the rotating scanning platform, wherein the mirror rotates about an axis via rotation of rotating scanning platform 114, or a rotating body of the rotating scanning platform such as rotating body 210 shown in FIGS. 2A-2C or FIGS. 3A-3B, discussed below. A controller 122 controls the output of light source 110 to control the beam 112 synchronously with controlling the movement of rotating scanning platform 114 via drive circuit 120. For example, the intensity of the beam 112 may be controlled and/or the beam may be turned on or off as a function of the rotational position of the rotating scanning platform 114. In the embodiment shown, rotating scanning platform 114 rotates about an axis in response to drive signals applied via drive circuit 120 to cause the scanned beam 124 to scan back and forth via movement of the optical device 116. The scanned beam 124 generates a scan line 126 on a projection surface 130. Although scanning system 100 of FIG. 1B illustrates a system in which a projected beam may be scanned across a projection surface, in one or more alternative embodiments, light source 110 may be substituted with a light detector or imager to detect or capture an image disposed on surface 130. For example, a bar code or similar code may be disposed on surface 130 and the detector or imager would detect or image the intensity of the various portions of the code as the rotating scanning platform 114 scans across the code. In yet further embodiments, although a one-dimensional scanning system 100 is shown in FIG. 1B for purposes of example, scanning system 100 may be easily extrapolated to a two-dimensional scanning system, for example by utilizing two rotating scanning platforms 114 in an appropriate arrangement, or by disposing rotating scanning platform 114 on a platform or device that is capable of moving the rotating scanning platform 114 along a second axis, or by otherwise controlling optical device 116 to provide such motion. In one or more embodiments, scan line 126 may comprise a two-dimensional raster where scanning system 100 is configured as a two-dimensional scanner. However, these are merely example embodiments for various applications of rotating scanning platform 114, and the scope of the claimed subject matter is not limited in these respects. Example designs for rotating scanning platform 114 are shown in and described with respect to FIGS. 2A-2C, below.

Referring now to FIGS. 2A-2C, diagrams of various rotating scanning platforms in accordance with one or more embodiments will be discussed. As shown in FIG. 2A, rotating scanning platform 114 comprises a rotating body 210 which in the embodiment shown comprises a ring or circular structure. The rotating body 210 is supported by two or more suspension flexures 212 and 214 that are fixed to a substrate via anchors 216 and 218 (or anchor points) of the suspension flexures 212 and 214, respectively. In some embodiments, rotating scanning platform 114 is fabricated as a MEMS device from silicon or a similar substrate material which provides for a sufficient amount of stiffness to allow suspension flexures to support rotating body 210 and any optical device 116 as shown in FIG. 1B that may be attached to the rotating body 210, yet which also provides for a sufficient amount of flexibility to allow rotation of rotating body 210 via flexing of the suspension flexures 212 and 214. In the embodiment shown, suspension flexure 212 and suspension flexure 214 are offset from the center of the rotating body 210 by a first total distance, d1. Similarly, the anchors 216 and 218 are offset from the center of the rotating body 210 by a second total distance, d2. Thus, in the arrangement shown in FIG. 2A, the lengths, L, of the suspension flexures from which the rotating body is suspended are able to be greater than the radius, R, of the rotating body 210, wherein the radius to length ratio has a value of about 0.87 in the ideal case. For a discussion of the ideal case, please refer to “Nonlinear Elastic Coupling in Tether-Suspended MEMS” by W. O. Davis et al., Micro Electro Mechanical Systems, 2005. MEMS 2005. 18^{th} IEEE Conference On, 30 Jan.-3 Feb. 2005, pages 129-132, which is hereby incorporated herein by reference in its entirety. In general, for a rotating body 210 supported by suspension flexures, in order to have linear stiffness for rotations of the body about axis of rotation 224, the ideal case is where the length, L, of the suspension flexures is greater than the radius, R, of the rotating body, such that R/L=0.87, and the suspension beams' neutral axes pass through the center of rotation. Without the offset d1, such an arrangement may be physically impossible to realize. To implement an approximation to the ideal case, the suspension flexures may be disposed in an offset arrangement as shown in the examples of FIGS. 2A-2C. This offset will reintroduce some amount of nonlinearity to the stiffness characteristics of the suspension flexures.

Although the rotating body 210 is shown as having a circular or ring shape in FIG. 2A, the rotating body 210 may have various other shapes depending on, for example, the performance requirements of the rotating scanning platform 114. For example, FIG. 2B shows the rotating body 210 having a generally oval shape, and FIG. 2C shows the rotating body 210 having a generally rectangular shape. However, these are merely example shapes for the rotating body 210 of rotating scanning platform 114, and the scope of the claimed subject matter is not limited in this respect.

Referring now to FIGS. 3A-3B, diagrams of various rotating scanning platforms having curved suspension flexures in accordance with one or more embodiments will be discussed. The rotating scanning platform 114 of FIG. 3A is substantially similar to the rotating scanning platforms 114 shown in FIGS. 2A-2C, more particularly similar to the rotating scanning platform 114 of FIG. 2C, except that the platform shown in FIG. 3A has curved suspension flexures 212 and 214 supporting rotating body 210. By providing a curvature to the suspension flexures 212 and 214, the linear stiffness characteristics of the ideal case can be recovered over a range of rotations of the body. Providing a curvature to the suspension flexures causes the spring characteristics of the suspension flexures to be generally more linear. In some embodiments, the offset may be increased or otherwise adjusted according to the amount of curvature of the suspension flexures 212 and 214, for example to avoid possible interference between the suspension flexures, and/or to achieve a desired amount of rotational stiffness linearity. Other design factors may be considered and accommodated as well, including for example the drive signal, stresses, modal behaviors, and the effects of the optical device 116 on the overall system. In general, the ratio of the radius (R) of rotating body 210 to length (L) of suspension flexure 212 and 214 may vary from about 0.8 to about 0.9 to achieve a suitable linearity of rotation, although the scope of the claimed subject matter is not limited in this respect. Further refinements of the suspension flexures and other compliant structures of the rotating scanning platform 114, for example the anchors 216 and 218, may include providing a non-constant cross sectional area in addition to curvature along their lengths to create a desired linear stiffness characteristic and/or to affect the stiffness of undesired motions. Furthermore, as shown in FIG. 3B, to additionally control and/or suppress undesired motions of the compliant structures of rotating scanning platform 114, additional suspension flexures or support beams may be provided, for example two additional suspension flexures 220 and 222 for a total of four suspension flexures supporting rotating body, two suspension flexures connected to respective anchors 216 and 218. Although four suspension flexures 212, 214, 216 and 218 are shown in the embodiment of FIG. 3B, any number of suspension flexures may be used to support rotational body 210 in various combinations attached to anchors, and the scope of the claimed subject matter is not limited in this respect.

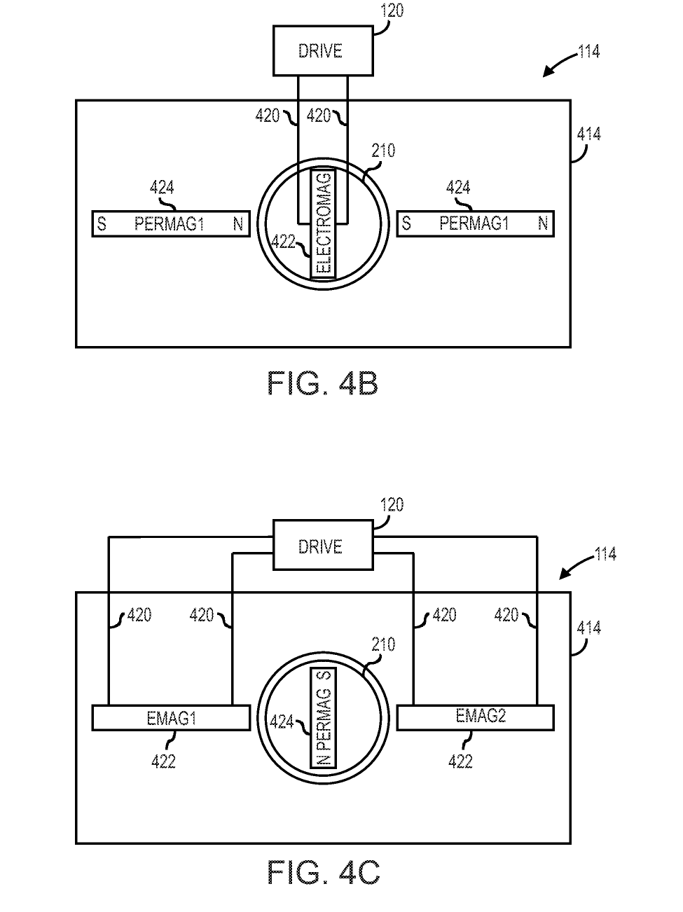

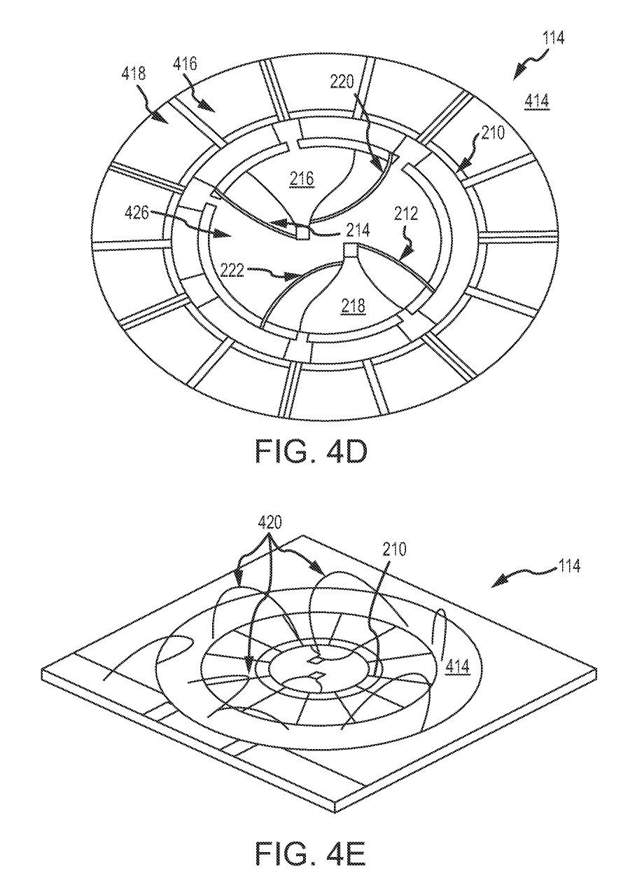

Referring now to FIGS. 4A-4C, diagrams of a rotating scanning platform showing various mechanisms for driving the scanner in accordance with one or more embodiments will be discussed. As shown in FIG. 4A, rotating scanning platform 114 may utilize electrostatic comb fingers 416 and 418 or actuators to drive the rotating body 210, and any optical device 116 or other device coupled or affixed to the rotating body 210, in a rotating manner. The example rotating scanning platform 114 of FIG. 4A is not necessarily illustrated to scale or proportion. Although FIG. 4A shows one set of electrostatic comb fingers 416 and 418 for purposes of example, in general there may be multiple sets of electrostatic comb fingers disposed about the periphery of rotating body 210. In one or more embodiments, the rotating drive mechanism may comprise electrostatic comb fingers or actuators generally operate at lower power levels and are generally compact. Furthermore, electrostatic comb fingers may be implemented where a non-resonant and/or quasistatic scanner is realized, for example the scanning system 100 of FIG. 1.

As shown in FIG. 4A, the rotating body 210 may have one or more support arms 410 disposed about the external periphery of rotating body 210. The support arms 410 support one or more sets of electrostatic comb fingers 416. Likewise, an outer body 414 may have one or more support arms 412 disposed about the internal periphery of outer body 414. The support arms 412 support one or more sets of comb fingers 418 that engage with a respective set of comb fingers 416 on support arms 410. The rotating body 210 is supported by suspension flexures 212, 214, 220, and 222 supported by anchors 216 and 218 at fixed points on a substrate (not shown). Drive circuit 120 provides a drive signal via drive lines 420 between the first set of comb fingers 416 on arms 410 and the second set of comb fingers 418 on arms 412 to electrostatically force the comb fingers toward their respective coupling set. Such motion thereby causes the rotating body to alternately rotate in a clockwise and counterclockwise direction according to the drive signal, resulting in a rotating motion of the optical device 116 or other device coupled to rotating body. It should be known that although a drive mechanism comprising electrostatic comb fingers is shown in FIG. 4A for purposes of example, other types of drive mechanisms, motors, or actuators may alternatively be utilized to cause the rotating motion of rotating body 210. For example, a motor circuit comprising a first set of coils disposed on rotating body 210 and a second set of coils disposed on outer body 414 may be utilized to drive rotating body 210, as one of many alternative examples, such as but not limited to various comb drives, other electrostatic drives, magnetic actuators, and so on, and the scope of the claimed subject matter is not limited in this respect.

As shown in FIG. 4B, rotating scanning platform 114 may utilize a moving coil system to drive the rotating body 210. Rotating body 210 may include an electromagnet 422 coupled to drive circuit 120 via drive lines 420. The outer body 414 may then have permanent magnets 424 disposed thereon, with one polarity (N) on one side of rotating body 210, and an opposite polarity (S) on the other side of rotating body 210. The electromagnet 422 and permanent magnets 424 provide a mechanism to cause rotating body 210 to rotate in response to a signal applied to electromagnet 422 by drive circuit 120. The magnetic polarity of the electromagnet 422 is controlled by the direction of current flow through the electromagnet 422 provided by drive circuit 120. In a first direction of current flow, the bottom end of electromagnetic 422 will have N polarity, and the top end of electromagnet 422 will have S polarity, thereby producing a counter clockwise (CCW) torque and causing rotating body 210 to rotate in a counter clockwise direction. In a second direction of current flow reversed from the first direction, the bottom end of electromagnet 422 will have S polarity, and the top end of electromagnet 422 will have N polarity, thereby producing a clockwise (CW) torque and causing rotating body 210 to rotate in a clockwise direction.

As shown in FIG. 4C, rotating scanning platform 114 may utilize a moving magnet system to drive rotating body 210. Rotating body 210 may include a permanent magnet 424 attached or fixed to the rotating body 210. The permanent magnet may have N polarity on a first end and S polarity on the second end. The outer body 414 may then have two electromagnets 422 disposed thereon, that receive drive current from drive circuit 120 via drive lines 420. The electromagnets 422 and permanent magnet 424 provide a mechanism to cause rotating body 210 to rotate in response to a signal applied to electromagnets 422 by drive circuit 120. The electromagnetic polarity of the electromagnets 422 depends on the direction of current flow as a result of the current applied by drive circuit 120. In a first direction of current flow, the right ends of the electromagnetics 422 will have N polarity and the left ends will have S polarity, thereby producing a counter clockwise (CCW) torque and causing rotating body 210 to rotate in a counter clockwise direction. In a second direction of current flow reversed from the first direction, the right ends of the electromagnets 422 will have S polarity and the left ends will have N polarity, thereby producing a clockwise (CW) torque and causing rotating body to rotate in a clockwise direction. It should be noted that the drive mechanisms shown in FIGS. 4A, 4B, and 4C are merely examples of various possible drive mechanisms of rotating scanning platform 114 to drive rotating body 210 in a rotating motion about an axis, and the scope of the claimed subject matter is not limited in this respect.

Referring now to FIGS. 4D-4E, diagrams of a rotating scanning platform showing an example implementation in accordance with one or more embodiments. The implementation shown in FIG. 4D and FIG. 4E is substantially similar to the implementation shown in FIG. 4A in which comb fingers are used to electrostatically drive the rotating scanning platform 114. As shown in FIG. 4D, rotating scanning platform 114 comprises a rotating body 210 that is supported by suspension flexures 212 and 214 which may function as primary springs, and suspension flexures 220 and 222 that may function as auxiliary springs. Suspension flexures 212 and 220 may couple to a first anchor 216, and suspension flexures 214 and 22 may couple to a second anchor 218. The anchors 216 and 218 may in turn be coupled to a substrate 426 which may comprise silicon or a similar material. The rotating body 210 may have multiple support arms 410 disposed about its periphery and supporting sets of comb finger 416, and the outer body may likewise have multiple support arms 412 disposed about an inner periphery and supporting sets of comb fingers 418 that interact electrostatically with comb fingers 416 of the rotating body 210. FIG. 4E shows an isometric view of the rotating scanning platform 114 of FIG. 4D showing the multiple drive lines 420 that connect to the comb fingers 416 and 418 to allow a drive circuit 120 to apply an appropriate drive current to the comb fingers 416 and 418. It should be noted that the rotating scanning platform 114 shown in FIG. 4D and FIG. 4E is merely one example implementation of a rotating MEMS scanner, and the scope of the claimed subject matter is not limited in these respects.

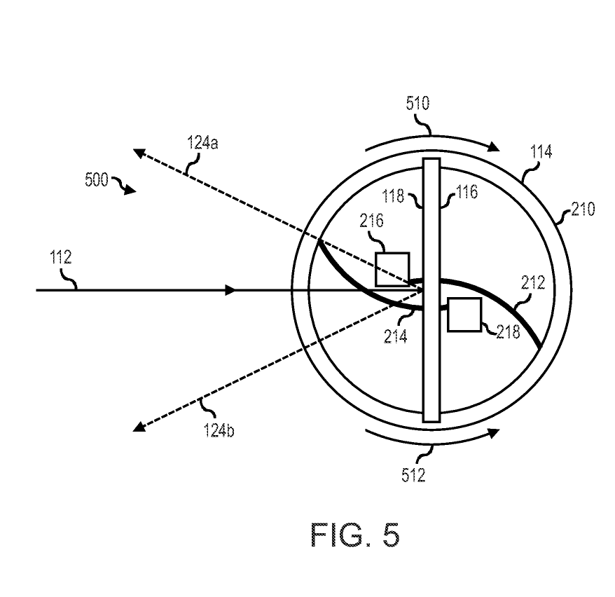

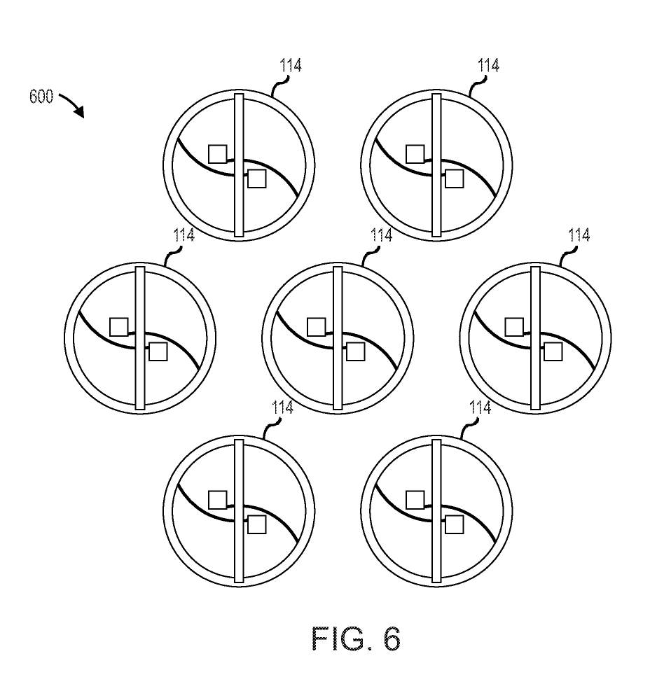

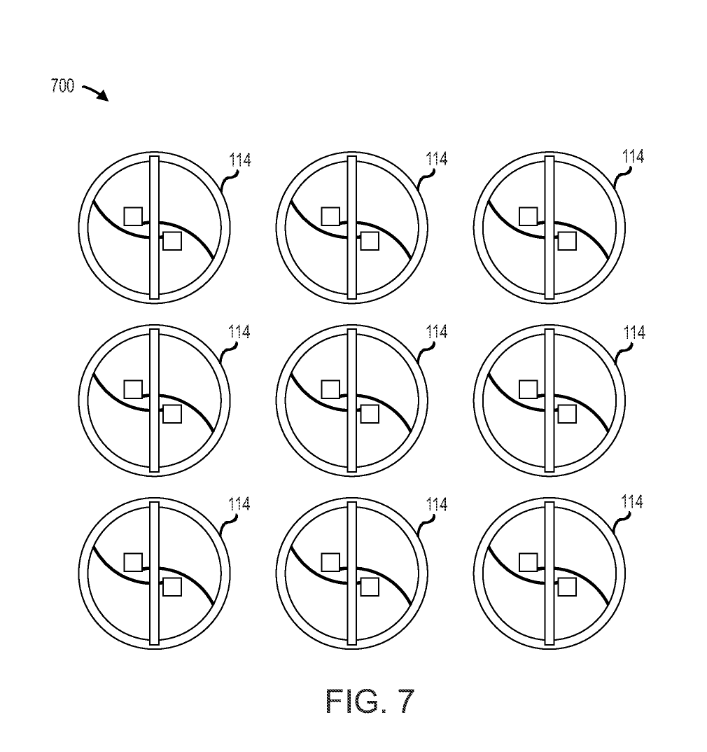

Referring now to FIG. 5, a diagram of a rotating scanning platform having a mirror disposed thereon illustrating a scan cone in accordance with one or more embodiments will be discussed. The rotating scanning platform 114 of FIG. 5 may have an optical device 116 affixed to the rotating body. For an example scanning system such as scanning system 100 of FIG. 1B, an incoming beam 112 may impinge on the optical device 116. In one or more embodiments, the optical device 116 may have a reflective or mirrored surface 118 that is capable of reflecting the incoming beam 112. If the rotating body 210 is driven to rotate in a clockwise direction 510, the reflected beam 124 is scanned toward a first relative maximally deflected position as reflected beam 124a. Likewise, if the rotating body 210 is driven to rotate in a counterclockwise direction 512, the reflected beam 124 is scanned toward a second maximally deflected position as reflected beam 124b. As the rotating body 210 rotates back and forth in both the clockwise and counterclockwise directions, the reflected beam 124 generates a scan cone 500, or a scan fan for a one dimensional scanner. Thus, the scanning platform 114 is capable of causing an incoming beam to be scanned at least in a linear direction that may be utilized in various optical devices such as scanners, imagers, and so on. Furthermore, although a reflective scanning platform 114 is shown in FIG. 5 for purposes of example, other types of optics 116 or devices may be coupled to rotating body 210 to implement various other types of scanners or optical devices or functions. For example, in one or more embodiments, optical device 116 may comprise a reflective material such as beryllium to limit dynamic deformation while keeping the weight of the optic to a lower or minimum value. Alternatively, optical device 116 may comprise a refractive material such as a prism formed from glass or plastic to cause the beam to be refracted or otherwise directed according to the rotation of the rotating body 210 and thus the optical device 116, wherein the beam 112 passes through optical device 116 and exits the side of optical device 116 opposite to the impinging side. Various other types of optics 116 or devices may likewise be utilized, and the scope of the claimed subject matter is not limited in this respect. Furthermore, the functional unit of rotating scanning platform 114 may be utilized in multiple arrays or arrangements to provide the functionality provided by multiple rotating scanning platforms 114 collectively. For example, several rotating scanning platforms 114 may be fabricated on a single substrate or die facing each other at appropriate angles to provide two-dimensional scanning, and/or raster correction. In addition, the optical device 116 may be mounted on rotating body 210 at an appropriate angle to provide exit cone correction and/or distortion correction functions such as to correct the smile distortion of a rotating scanning platform 114. Furthermore, the optical device 116 may have selected curvature or other optical properties to result in a desired increase or decrease in optical power, a desired exit pupil, and so on. However, these are merely example implementations of one or more rotating scanning platforms 114 using various types of optics 116, and the scope of the claimed subject matter is not limited in these respects. An example array of rotating scanning platforms is shown in and described with respect to FIG. 6, below.

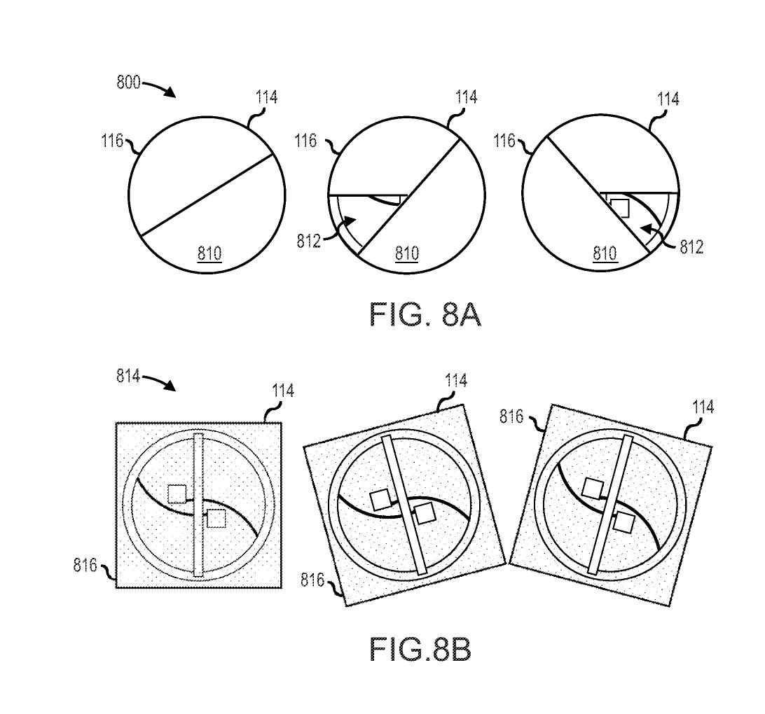

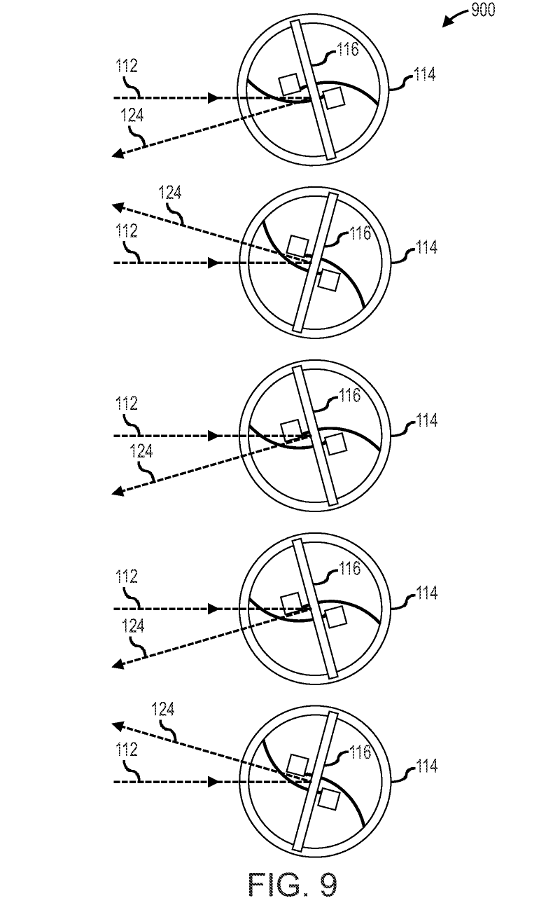

Referring now to FIG. 6 and FIG. 7, diagrams of an array of rotating scanning platforms in a general hexagonal arrangement in accordance with one or more embodiments will be discussed. As shown in FIG. 6, multiple rotating scanning platforms 114 may be arranged collectively in an array 600, for example in a hexagonal array. As shown in FIG. 7, multiple rotating scanning platforms 114 may be arranged in a generally rectilinear array 700. By arranging multiple rotating scanning platforms 114 acting as functional units that may be controlled collectively, various functions and or devices may be realized. Such arrays may be utilized for scanning, switching, routing, and/or imaging applications. The rotating scanning platforms 114 may be arranged in arrays having higher fill factors wherein the platforms are placed closer together, and may provide rotational motion, torsional around a horizontal axis, torsion around a vertical axis, and/or in a pumping mode. Comb finger actuators may be disposed inside or outside the rotating bodies wherein various combinations of comb sets can be selectively energize to select a desired motion. Additional electrodes may be placed underneath or on top of one or more of the rotating scanning platforms 114 to allow for various actuation modes. Where the rotating scanning platforms are fabricated in silicon or the like, for example as microelectromechanical systems (MEMS) devices, electrical connections may be fed through the back side of the silicon wafer using complementary metal oxide semiconductor (CMOS) integration and/or through silicon vias (TSV) in one or more embodiments. Furthermore, the arrays of rotating scanning platforms may be scalable to larger sized arrays wherein the dimensions of the features of the rotating scanning platform 114 may range from about 100 micrometers (μm) to about several millimeters (mm), although the scope of the claimed subject matter is not limited in this respect. In some embodiments, one or more of the rotating scanning platforms 114 may have an optical element 116 comprising a mirror, a prism, a lens, a phase grating, an amplitude grating, and so on. Furthermore, the optical elements 116 may comprise sub-wavelength grating that may be used to form an array of rotating scanning platforms 114 having a larger fill-factor. It should be noted that these are merely example implementations of an array of rotating scanning platforms 114, and the scope of the claimed subject matter is not limited in these respects. Furthermore, other types of devices may be mounted to the rotating scanning platforms 114 as the optical elements 116 to provide additional collective functioning of the array, for example as shown in and described with respect to FIGS. 8A and 8B, below.

Referring now to FIGS. 8A and 8B, diagrams of an array of scanning platforms used as a dynamic aperture or to reduce speckle in accordance with one or more embodiments will be discussed. In the embodiment shown in FIG. 8A, the optical elements 116 may comprise dynamically controlled apertures 810 that open and close in response to the amount of rotation of the rotating scanning platform 114. For example, an aperture 810 may be closed when the rotating scanning platform 114 is in a first position, and may be open when the rotating scanning platform 114 is rotated into a second position. The size of the aperture openings 812 may be proportional to the amount or rotation of the rotating scanning platform 114. Collectively, an array 800 of such dynamically controlled apertures may operate together depending on the desired application. However, this is merely one example application of an array 800 of dynamically controlled apertures, and the scope of the claimed subject matter is not limited in this respect.

In the embodiment shown in FIG. 8B, the optical elements 116 of the rotating scanning platforms 114 may comprise an optical diffuser 816 or similar element such as microlens array (MLA) that may be dynamically rotated via motion of the rotating scanning platforms 114, for example to reduce speckle in a scanned beam display such as scanning system 100 of FIG. 1. In some embodiments, the optical elements 116 may comprise generally square shaped optical diffusers 816 in order to achieve a higher fill factor, although other shapes may be utilized as well. Such optical diffusers 816 may be rotated clockwise and counterclockwise in response to the movement of the rotating scanning platforms 114. For example, the array 814 of optical diffusers 816 may be used as a dynamic diffuser to reduce or destroy the coherence of a light beam for speckle reduction. In some embodiments the rotating scanning platforms 114 may be actuated at relatively higher frequencies depending on the application to achieve the desired amount of speckle reduction. However, this is merely one example application of an array 814 of optical diffusers 816, and the scope of the claimed subject matter is not limited in this respect. Furthermore, other various types of optical devices may be utilized instead of a diffuser, for example a diffraction grating, and the scope of the claimed subject matter is not limited in this respect.

Referring now to FIG. 9, a diagram of a phased array of rotating scanning platforms used for beam steering in accordance with one or more embodiments will be discussed. As shown in FIG. 9, multiple rotating scanning platforms 114 may be arranged in a linear array 900. The rotating scanning platforms 114 may have optical elements 116 comprising mirrors that may be independently controlled to reflect individual beams 112 as individual reflected beams 124. The independently controlled beams may be utilized for phased-array beam steering applications such as light detection and ranging (LIDAR) or range finding. In such an arrangement, the optical elements may be mounted perpendicular or nearly perpendicular on the rotating bodies 210 of the respective rotating scanning platforms 114. Similar applications may likewise be realized with a linear array of rotating scanning platforms, and the scope of the claimed subject matter is not limited in this respect.

In general, the rotating scanning platform 114 may be utilized in various devices that utilize one or more scanning platforms 114 to implement one or more functions of the device. For example, such devices may comprise, but are not limited to microfluidic valves or switches, microfluidic configurable surfaces, microfluidic orientation sensors mounted to the rotating scanning platform, optical switches using a fiber mounted to the rotating scanning platform, a shutter or variable optical attenuator (VOA), any application or device involving hidden flexures and/or a compact form factor provided by the rotating scanning platform, a variable capacitor or inductor or other electrical device, a mechanical switch, a gear train, a encoder wheel, a dithered gyroscope, a steerable precision aiming device, a steerable precision aiming device using three rotating scanning platforms 114 for 3-axis steering, or combined with other scanner types, a rotating scanning platform 114 wherein some combs in the comb drive system are used for sensing, a magnetic field sensor using integral current loop or permanent magnet mounted to rotary platform, among others. However, it should be noted that these devices are merely example applications in which one or more rotating scanning platforms 114 may be used, and the scope of the claimed subject matter is not limited in these respects.

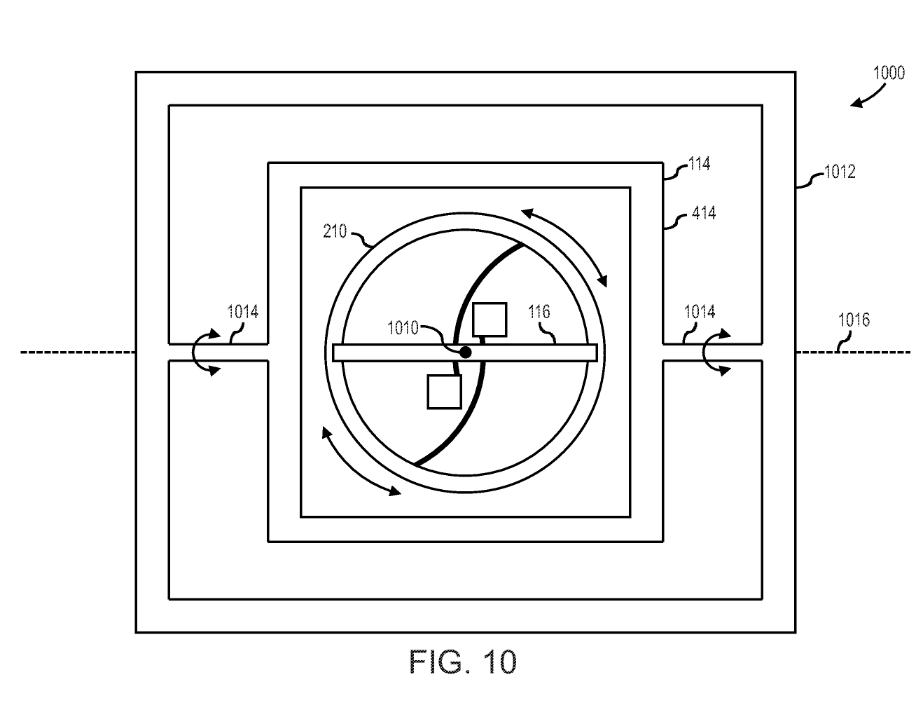

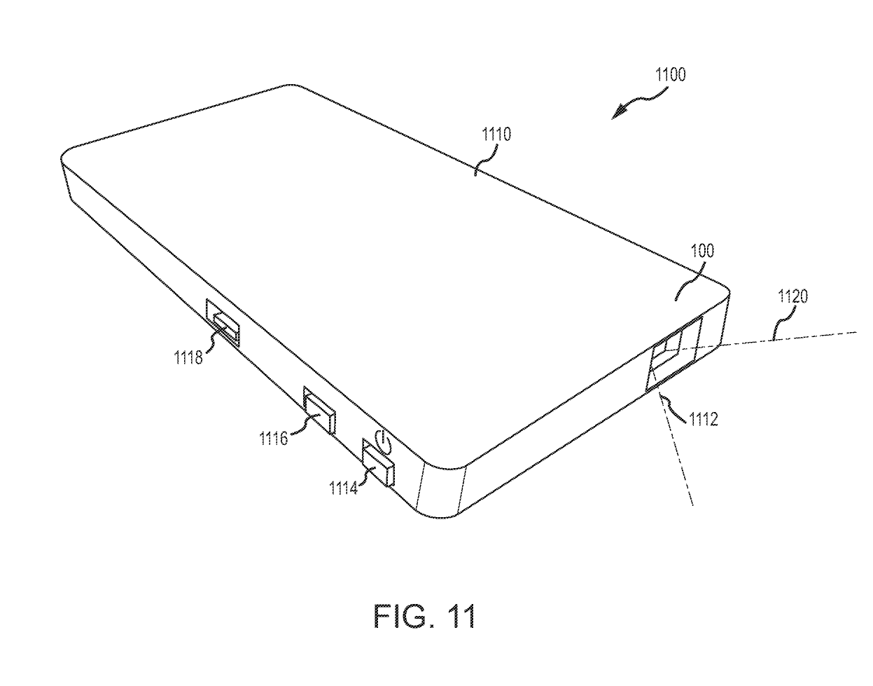

Referring now to FIG. 10, a diagram of a biaxial scanner including a rotating scanning platform in accordance with one or more embodiments will be discussed. As shown in FIG. 10, biaxial scanner 1000 may include a rotating scanning platform 114 as shown in and described with respect to FIG. 4A, wherein the rotating scanning platform 114 includes a rotating body 210 suspended by an outer body 414 and supporting an optical device 116 that is rotated about a first axis 1010. The drive circuit 120 and corresponding drive system is not shown in FIG. 10. To provide rotation about a second axis 1016, the rotating scanning platform 114 may be suspended by body 1012 via flexures 1014. The rotating scanning platform 114 may be driven to rotate about the second axis 1016 via another drive system not shown in FIG. 10. Driving the rotating scanning platform 114 about axis 1016 while driving the rotating body 210 about the first axis 1010 may allow for the optical device 116 to be manipulated in two orthogonal directions, for example to provide a two-dimension scanned beam projector. However, is should be noted that the biaxial scanner 1000 of FIG. 10 is merely one example of how to provide two-dimensional scanning with a rotating scanning platform 114, and the scope of the claimed subject matter is not limited in this respect.

Referring now to FIG. 11, an isometric view of a projector having the scanning system with a rotating scanning platform of FIG. 1B in accordance with one or more embodiments will be discussed. The projector 1100 of FIG. 11 represents one example application of scanning system 100 having a rotating scanning platform 114 as discussed herein. In some embodiments, scanning system 100 may be configured as a two-dimensional beam scanning system, for example by incorporating the biaxial scanner 1000 of FIG. 10, to project a two-dimensional image, although the scope of the claimed subject matter is not limited in this respect. Projector 1100 may comprise a housing 1110 housing scanning platform 100 including rotating scanning platform 114 among other components such as a battery, input/output circuits, and so on. The housing 1110 may include a power button 1114 and a menu button 1116, and may include an input/output (I/O) port 1118 for providing a video signal to be displayed scanning system 100, which optionally may also include a power line for powering the projector 1100 and/or for charging the battery. The scanning system 100 scans a beam in a scan cone 1120 projected through window 1112. An example of such a projector is a SHOWWX+PICOP projector available from Microvision, Inc. of Redmond, Wash., USA.

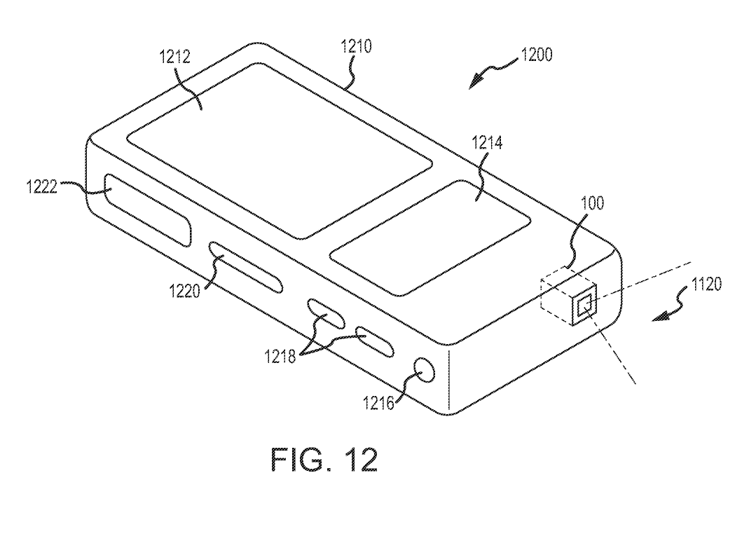

Referring now to FIG. 12, an isometric view of an information handling system having a scanning system that includes a rotating scanning platform in accordance with one or more embodiments will be discussed. As shown in FIG. 12, information handling system 1200 may comprise any of several types of computing platforms, including cell phones, personal digital assistants (PDAs), netbooks, notebook computers, internet browsing devices, tablets, pads, and so on, and the scope of the claimed subject matter is not limited in this respects. In the example shown in FIG. 12, information handling system 1200 may comprise a housing 1210 to house scanning system 100 having a rotating scanning platform 114 as discussed herein to provide a scanned output beam 112 to project an image. Scanning system 100 projects a beam to generate scan cone 1120. In some embodiments, scanning system 100 may be configured as a two-dimensional beam scanning system, for example by incorporating the biaxial scanner 1000 of FIG. 10, to project a two-dimensional image, although the scope of the claimed subject matter is not limited in this respect. Information handling system 1200 optionally may include a display 1212, keyboard 1214 or other control buttons or actuators, a speaker or headphone jack 1216 with optional microphone input, control buttons 1218, memory card slot 1220, and/or input/output (I/O) port 1222, or combinations thereof. Furthermore, information handling system 1200 may have other form factors and fewer or greater features than shown, and the scope of the claimed subject matter is not limited in these respects.

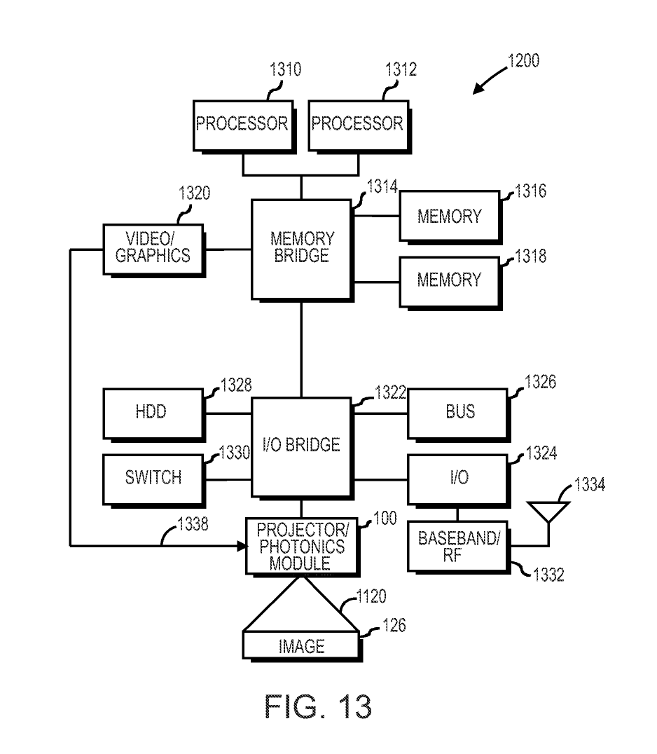

Referring now to FIG. 13, a block diagram of an example architecture of the information handling system of FIG. 12 in accordance with one or more embodiments will be discussed. Although FIG. 13 shows one example architecture of the information handling system 1200 of FIG. 12, information handling system 1200 may include more or fewer elements and/or different arrangements of the elements than shown in FIG. 13, and the scope of the claimed subject matter is not limited in these respects. Information handling system 1200 may comprise one or more processors such as processor 1310 and/or processor 1312, which may comprise one or more processing cores in some embodiments. One or more of processor 1310 and/or processor 1312 may couple to one or more memories 1316 and/or 1318 via memory bridge 1314, which may be disposed external to processors 1310 and/or 1312, or alternatively at least partially disposed within one or more of processors 1310 and/or 1312. Memory 1316 and/or memory 1318 may comprise various types of semiconductor based memory, for example volatile type memory and/or non-volatile type memory. Memory bridge 1314 may couple to a video/graphics system 1320 to drive a scanning system 100 via control and/or data lines 1338. Scanning system 100 may comprise a photonics module, coupled to information handling system 1200. The photonics module may comprise the scanning system 100 of FIG. 1B including a rotating scanning platform 114. In one or more embodiments, video/graphics system 1320 may couple to one or more of processors 1310 and/or 1312 and may be disposed on the same substrate or die as processor 1310 and/or 1312, although the scope of the claimed subject matter is not limited in this respect.

Information handling system 1200 may further comprise input/output (I/O) bridge 1322 to couple to various types of I/O systems. I/O system 1324 may comprise, for example, a universal serial bus (USB) type system, an IEEE 1394 type system, or the like, to couple one or more peripheral devices to information handling system 1200. Bus system 1326 may comprise one or more bus systems such as a peripheral component interconnect (PCI) express type bus or the like, to connect one or more peripheral devices to information handling system 1200. A hard disk drive (HDD) controller system 1328 may couple one or more hard disk drives or the like to information handling system, for example Serial Advanced Technology Attachment (Serial ATA) type drives or the like, or alternatively a semiconductor based drive comprising flash memory, phase change, and/or chalcogenide type memory or the like. Switch 1330 may be utilized to couple one or more switched devices to I/O bridge 1322, for example Gigabit Ethernet type devices or the like. Furthermore, as shown in FIG. 13, information handling system 1200 may include a baseband and radio-frequency (RF) block 1332 comprising a base band processor and/or RF circuits and devices for wireless communication with other wireless communication devices and/or via wireless networks via antenna 1334, although the scope of the claimed subject matter is not limited in these respects.

In one or more embodiments, information handling system 1200 may include a photonics module which may include any one or more or all of the components of scanning system 100 of FIG. 1B such as rotating scanning platform 114, drive circuit 120, and/or light source 110 which may include a blue laser, green laser, and/or red laser, or combinations thereof. In one or more embodiments, the photonics module may be controlled by one or more of processors 1310 and/or 1312 to implement some or all of the functions of controller 122 of FIG. In one or more embodiments, the photonics module provides a scanned output beam 1120 to project an image 126. In some embodiments, scanning system 100 may be configured as a two-dimensional beam scanning system, for example by incorporating the biaxial scanner 1000 of FIG. 10, to project a two-dimensional image, although the scope of the claimed subject matter is not limited in this respect. The embodiments discussed herein are merely example implementations of information handling system 1200, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to a rotating MEMS scanner and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A rotating scanning platform, comprising:
a rotating body; and
two or more suspension flexures to support the rotating body at a first end of respective suspension flexures, wherein the suspension flexures have a length that is greater than a radius of the rotating body, and the suspension flexures are disposed at an offset from a center of rotation of the rotating body;
wherein the suspension flexures are fixed, respectively, to a substrate at a second end at a location that is closer to the center of rotation than to the first end of a respective suspension flexure to allow the rotating body to rotate about the center of rotation in response to a drive signal.

2. A rotating scanning platform as claimed in claim 1, wherein the suspension flexures are generally linear, or generally curved, or combinations thereof.

3. A rotating scanning platform as claimed in claim 1, wherein the suspension flexures have a non-constant cross-sectional area that varies along a length of the suspension flexures.

4. A rotating scanning platform as claimed in claim 1, wherein the rotating body is generally circular, oval, or rectangular, or combinations thereof.

5. A rotating scanning platform as claimed in claim 1, further comprising comb actuators, a rotating magnet drive system, or a rotating electromagnet drive system, to cause the rotating body to rotate in response to the drive signal.

6. A rotating scanning platform as claimed in claim 1, further comprising an optical device coupled to the rotating body, wherein the optical device rotates about an axis via rotation of the rotating body.

7. A rotating scanning platform as claimed in claim 1, further comprising a mirror that is oriented to be non-planar with the rotating body, wherein the mirror rotates about an axis via rotation of the rotating body.

8. A scanning system, comprising:
a rotating scanning platform, wherein the rotating scanning platform comprises:
a rotating body;
an optical device coupled to the rotating body; and
two or more suspension flexures to support the rotating body at a first end of respective suspension flexures, wherein the suspension flexures have a length that is greater than a radius of the rotating body, and the suspension flexures are disposed at an offset from a center of rotation of the rotating body;
wherein the suspension flexures are fixed, respectively, to a substrate at a second end at a location that is closer to the center of rotation than to the first end of a respective suspension flexure to allow the optical device to rotate about the center of rotation in response to a drive signal that rotates the rotating body.

9. A scanning system as claimed in claim 8, further comprising:
a light source to direct a light beam on the optical device; and
a drive circuit to provide the drive signal and to control the light source to cause a reflected beam to be scanned onto a projection surface.

10. A scanning system as claimed in claim 8, wherein the optical device comprises a mirror, a lens, a curved mirror, a prism, a diffraction grating, an aperture, an optical diffuser, or a microlens array, or combinations thereof.

11. A scanning system as claimed in claim 8, further comprising one or more additional rotating scanning platforms, wherein the rotating scanning platforms are disposed in an array.

12. A scanning system as claimed in claim 8, further comprising one or more additional rotating scanning platforms, wherein the rotating scanning platforms are independently controlled to reflect one or more light beams in a phased array.

13. A scanning system as claimed in claim 8, further comprising one or more additional rotating scanning platforms, wherein the rotating scanning platforms are arranged to scan the light beam in two dimensions to generate a two-dimensional image on the projection surface.

14. A scanning system as claimed in claim 8, further comprising one or more additional rotating scanning platforms, wherein the optical devices comprise dynamically controlled apertures controlled based on the rotation of the rotating bodies to operate collectively as an aperture.

15. A scanning system as claimed in claim 8, further comprising one or more additional rotating scanning platforms, wherein the optical devices comprise light diffusers controlled based on the rotation of the rotating bodies to operate collectively to reduce speckle of an image projected through the light diffusers.

16. A scanning system as claimed in claim 8, wherein the rotating scanning platform is capable of rotating about a first axis and is coupled to another platform that is capable of moving the rotating scanning platform about a second axis to provide two-dimensional scanning.

17. An information handling system, comprising:
a processor and a memory coupled to the processor;
a projector coupled to the processor to project an image stored in the memory onto a projection surface, wherein the projector comprises:
a rotating scanning platform comprising a rotating body, an optical device coupled to the rotating body, and two or more suspension flexures to support the rotating body at a first end of respective suspension flexures, wherein the suspension flexures have a length that is greater than a radius of the rotating body, and the suspension flexures are disposed at an offset from a center of rotation of the rotating body, wherein the suspension flexures are fixed, respectively, to a substrate at a second end at a location that is closer to the center of rotation than to the first end of a respective suspension flexure to allow the optical device to rotate about the center of rotation in response to a drive signal that rotates the rotating body;
a light source to direct a light beam on the optical device; and
a drive circuit to provide the drive signal and to control the light source to cause a reflected beam to be scanned onto the projection surface.

18. An information handling system as claimed in claim 17, further comprising one or more additional rotating scanning platforms, wherein the rotating scanning platforms are arranged to scan the light beam in two dimensions to generate a two-dimensional image on the projection surface.

19. An information handling system as claimed in claim 17, wherein the rotating scanning platform is capable of rotating about a first axis and is coupled to another platform that is capable of moving the rotating scanning platform about a second axis to cause the light beam to be scanned in two dimensions to generate a two-dimensional image on the projection surface.

20. An information handling system as claimed in claim 17, wherein the suspension flexures are generally curved.
